(19) United States
(12) Patent Application Publication
(10) Pub. No.: US 2026/0274184 A1
(43) Pub. Date: Sep. 17, 2026

(54) SOUND SYSTEM FOR A VEHICLE

(71) Applicant: NISSAN NORTH AMERICA, INC., Franklin, TN (US)

(72) Inventor: Farokh KAVARANA, Novi, MI (US)

(21) Appl. No.: 19/079,705

(22) Filed: Mar. 14, 2025

(51) Int. Cl. B60R 16/023; B60W 60/00; G08B 3/00

(52) U.S. Cl. CPC B60R 16/0231; B60W 60/001; G08B 3/00; B60W 2520/06; B60W 2520/10; B60W 2720/10; B60W 2720/24

(57) ABSTRACT

A sound system for a vehicle includes an input, a storage device, a speaker system, a sensor system, a CAN, and an electronic controller. The input enables a user to select a sound package from a plurality of sound packages. The storage device stores the sound package. The sensor system senses a parameter pertaining to the vehicle. The CAN receives an electronic signal from the sensor system, the electronic signal pertaining to the parameter. The electronic controller determines a corresponding sound from the sound package based on the electronic signal received by the CAN and operates the speaker system to play the sound.

### BACKGROUND

### Technical Field

The present disclosure generally relates to a sound system for a vehicle. More specifically, the present disclosure relates to a sound system for a vehicle that plays a sound based on a corresponding parameter of a vehicle.

### Background Information

Conventional sound systems in vehicles generally play preprogrammed sound files. For example, some conventional electric vehicles play internal combustion engine sounds. Other conventional vehicles play preprogrammed sounds when locking or unlocking the vehicle.

### SUMMARY

It has been discovered that an improved sound system to play individual or user selected sounds is desired. It has been determined that conventional sounds are played merely by playing a sound that is stored in a stored file and played when an activity occurs. For example, the horn of a vehicle sounding when a door is locked.

Such sounds do not provide a variety of persecuted sounds played based on determination of a controller from information received from a sensor system through a Controller Area Network (CAN).

In view of the state of the known technology, one aspect of the present disclosure is to provide a sound system for a vehicle, comprising an input, a storage device, a speaker system, a sensor system, a CAN, and an electronic controller. The input is configured to enable a user to select a sound package from a plurality of sound packages. The storage device is configured to store the sound package. The sensor system is configured to sense a parameter pertaining to the vehicle. The CAN is configured to receive an electronic signal from the sensor system, the electronic signal pertaining to the parameter. The electronic controller is configured to determine a corresponding sound from the sound package based on the electronic signal received by the CAN and operate the speaker system to play the sound.

Another aspect of the present disclosure is to provide a method of operating a sound system for a vehicle, comprising operating an input to select a sound package from a plurality of sound packages, storing the sound package in a storage device, sensing a parameter pertaining to the vehicle with a sensor system, receiving an electronic signal from the sensor system with a CAN, the electronic signal pertaining to the parameter, determining with an electronic controller a corresponding sound from the sound package based on the electronic signal received by the CAN, and operating the speaker system to play the sound.

By providing a system and method as described herein, an improved user experience can be obtained. A user can select and organize specific sounds that are associated with specific vehicle operations. Moreover, the vehicle can provide specific sounds to vehicle occupants and external observers that provide notification of an operation that should be performed or notification that the vehicle is intending to or in the process of performing a specific operation.

Another aspect of the present disclosure is to provide a non-transitory machine-readable medium storing instructions which, when executed by one or more processor, causes the one or more processor to execute the methods disclosed herein.

### BRIEF DESCRIPTION OF THE DRAWINGS

Referring now to the attached drawings which form a part of this original disclosure:

FIG. 1 is a schematic of a vehicle including one embodiment of the sound system of the present disclosure;

FIG. 2 is a schematic illustration of the sound system illustrated in FIG. 1;

FIG. 3 illustrates the storage device storing the sound packages used in the sound system illustrated in FIG. 1;

FIG. 4A is a schematic illustration of the sound system illustrated in FIG. 1 in use with a vehicle traveling along a road;

FIG. 4B is a schematic illustration of the sound system illustrated in FIG. 4 with the controller altering the speed of the vehicle;

FIG. 5A is a schematic illustration of the sound system of FIG. 1 in use with a user approaching the vehicle;

FIG. 5B is a schematic illustration of the sound system of FIG. 5 with the operation of a door of the vehicle;

FIG. 6 is a chart illustrating specific operation of the sound system;

FIG. 7 illustrates user input and selection of the sound packages for operation of the sound system;

FIG. 8 is a flow chart illustrating operation of the sound system; and

FIG. 9 is a flow chart illustrating operation of the sound system.

It should be noted that these figures are intended to illustrate the general characteristics of methods, structure and/or materials utilized in certain illustrative embodiments and to supplement the written description provided below. These drawings are not to scale and may not precisely reflect the precise structural or performance characteristics of any given embodiment and should not be interpreted as defining or limiting the range of values or properties encompassed by illustrative embodiments unless specified.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the disclosure as defined by the appended claims and their equivalents.

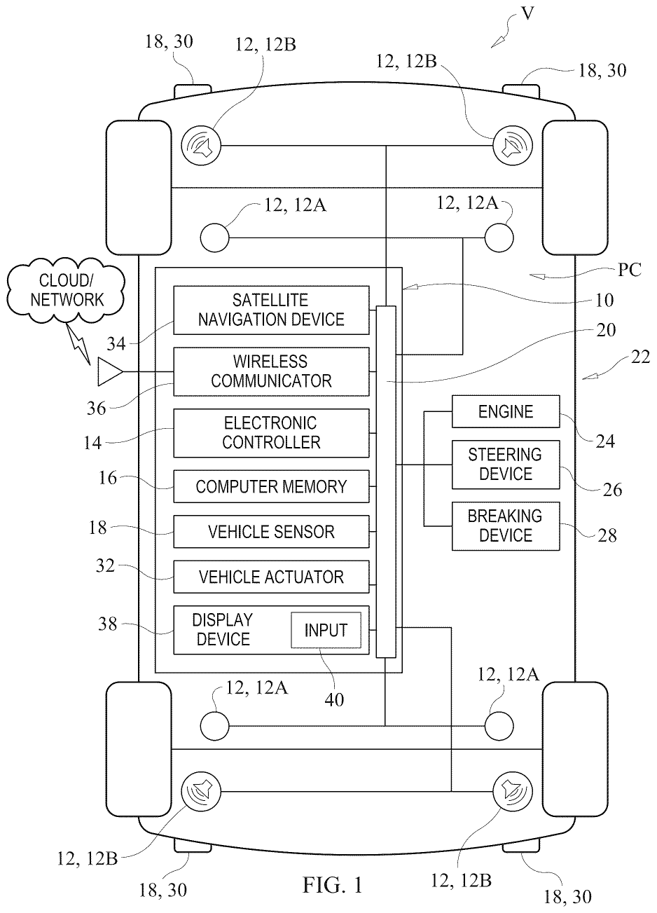

Referring initially to FIG. 1, a vehicle V including a sound system 10 is illustrated in accordance with a first embodiment. The sound system 10 includes a speaker system 12, an electronic controller 14, a computer memory (storage device) 16, a sensor system 18 and controller area network (CAN) bus 20.

In the illustrated embodiment, the vehicle V is equipped with the sound system 10, which can be a standalone or separate system or can be part of a vehicle control system 22. In the illustrated embodiment, the sound system 10 operates as a component or a subsystem of the vehicle control system 22. The vehicle control system 22 can include various systems and controls that enable the vehicle control system 22 to operate various vehicle V systems.

For example, in one embodiment, the vehicle control system 22 can control operation of the sound system 10, operation of vehicle entry devices (doors, etc.) and operation of a driving support system that supports driving of the vehicle V. The term “driving support system” as used herein may include an autonomous driving control and a driving assist control. In such an embodiment, the autonomous driving control performs all driving tasks without human intervention, such as automatically navigating the vehicle V along a planned route without human intervention. The driving assist control can also be designed to assist the driver in a limited range of functions focused on specific driving tasks but still require human supervision and/or input.

Furthermore, in the illustrated embodiment, the driving support system according to the present disclosure assists the driver at least in operations of lane change of the vehicle V or vehicle speed control, as discussed in more detail below. In the illustrated embodiment, an example is illustrated in which the driving support system is integrated with the vehicle control system 22. However, the driving support system can be a separate system from the vehicle control system 22 and be operated according to instructions or information from the vehicle control system 22.

As also seen in FIG. 1, the vehicle V is equipped with a vehicle engine 24 and other conventional vehicle components, such as a steering device 26, a braking device 28, etc. These components can be considered part of the vehicle control system 22. As can be understood, any component of the vehicle V that enables operation of the vehicle and/or control of the vehicle V can be considered an element of the vehicle control system 22. The vehicle engine 24 generates a torque output of the vehicle V in accordance with the operation of the vehicle pedal by the driver. The torque output generated by the vehicle engine 24 is then transferred to the wheels of the vehicle V through the transmission and the drivetrain of the vehicle V in a conventional manner. The vehicle engine 24 can be further equipped with an electronic control unit (ECM). In particular, the ECM controls a torque output of the vehicle engine 24. In the illustrated embodiment, the vehicle engine 24 includes an electric engine. Alternatively, the vehicle V can be a hybrid or a combustion vehicle, or be operated by a hydrogen powertrain.

In the illustrated embodiment, the vehicle control system 22 includes the electronic control unit or controller 14 (e.g., a processor) and the computer memory 16. The electronic controller 14 includes one or more processor(s) for controlling the various operations of the vehicle V, as will be further described. In the illustrated embodiment, the electronic controller 14 is preferably a microcomputer (MPU) or central processing unit (CPU). The electronic controller 14 is formed of one or more semiconductor chips that are mounted on a circuit board. The term “electronic control unit” or “electronic controller” as used herein refers to hardware that executes a software program, and does not include a human being. The MPU or CPU may be one or more integrated circuits having firmware for causing the circuitry to complete the activities described herein. Of course, any number of other analog and/or digital components capable of performing the functionality described below can be provided in place of, or in conjunction with the electronic controller 14.

The computer memory 16 is any memory or computer memory 16. Here, for example, the computer memory 16 includes a transitory or non-transitory computer-readable medium with the sole exception of a transitory propagating signal. Thus, the computer memory 16 can include nonvolatile memory and volatile memory, and can include at least one of an internal memory, or other type of memory devices such as a read-only memory (ROM), an erasable programmable read only memory (EPROM), an electrically erasable programmable read-only memory (EEPROM), a random access memory (RAM), a hard disk, a flash drive, etc. The computer memory 16 stores various control processes or control programs as well as information or data used by the electronic controller 14. Thus, the computer memory 16 is electrically connected to the electronic controller 14. In this way, the electronic controller 14 can retrieve data and access programs stored in the computer memory 16, and can store data to the computer memory 16. As explained below, the computer memory 16 preferably includes non-volatile memory that is configured to store various control programs (e.g., a program for a vehicle V control method, etc.), operational data, component identification data, etc.

As can be understood, in this embodiment the electronic controller 14 and the memory device 16 are illustrated as both the electronic controller and memory device of the vehicle control system 22 and the sound system 10. However, it is noted that these systems can have individual controllers, multiple controllers or share a controller. A single controller is illustrated for convenience and is simply exemplary of the operation of these systems.

In the illustrated embodiment, the vehicle control system 22 can further include the sensor system 18. The sensor system 18 detects traveling environment of the vehicle V, as will be further discussed below. For example, the sensor system 18 can be equipped with one or more unidirectional or omnidirectional external cameras 30 that take moving or still images of the traveling environment or surroundings of the vehicle V. The sensor system 18 can also include infrared detectors, ultrasonic detectors, radar detectors, photoelectric detectors, magnetic detectors, acceleration detectors, acoustic/sonic detectors, gyroscopes, lasers or any combination thereof. The sensor system 18 can also include object-locating sensing devices including range detectors, such as FM-CW (Frequency Modulated Continuous Wave) radars, pulse and FSK (Frequency Shift Keying) radars, sonar and Lidar (Light Detection and Ranging) devices. The data from the sensor system 18 can be used to detect the environment of the vehicle V, as will be further described below. In any case, in the illustrated embodiment, the sensor system 18 includes at least one of a lidar sensor (Lidar), a radar sensor (radar) and an image sensor (camera).

The sensor system 18 further includes various sensors to detect driving states of the vehicle V. For example, the sensor system 18 includes a vehicle speed sensor, a yaw rate sensor, a torque sensor, etc. The vehicle speed sensor can measure wheel speed of the vehicle V in a conventional manner to detect current vehicle speed of the vehicle V. The yaw rate sensor detects the yaw rate generated in the vehicle V in a conventional manner. The torque sensor can measure the torque on the crankshaft of the vehicle engine 24 in a conventional manner.

In the illustrated embodiment, the vehicle control system 22 further includes a vehicle actuator 32, a satellite navigation device 34 and a wireless communicator 36. The vehicle actuator 32 is operatively connected to the electronic controller 14 to operate vehicle V components of the vehicle V according to the autonomous driving control and/or the driving assist control. Specifically, the vehicle actuator 32 includes a steering actuator, a brake control actuator, etc. The steering actuator operates the steering device of the vehicle V to control the steering angle of the vehicle V. The brake control actuator operates the braking device to control the deceleration of the vehicle V. In the illustrated embodiment, the electronic controller 14 can be in communication with the ECM of the vehicle engine 24 to operate the vehicle engine 24 to control the acceleration of the vehicle V. However, the vehicle actuator 32 can further include an accelerator opening actuator that operates the throttle of the vehicle engine 24 to control the acceleration of the vehicle V.

The satellite navigation device 34 includes a global navigation satellite system (GNSS) receiver. In the illustrated embodiment, the GNSS receiver can be a global positioning system (GPS) receiver, for example. The satellite navigation device 34 receives radio waves from a plurality of navigation satellites to obtain information that represents, for example, a current vehicle heading of the vehicle, a current vehicle position of the vehicle in two or three dimensions, a current vehicle angular orientation of the vehicle, or a combination thereof.

The wireless communicator 36 is in wireless communications to at least one of cloud services and a vehicle network. The wireless communicator 36 is a hardware device capable of transmitting and/or receiving an analog or digital signal wirelessly via an antenna. The terms “wireless communicator” as used herein include a receiver, a transmitter, a transceiver, or a transmitter-receiver, for example. The wireless communication signals can be radio frequency (RF) signals, ultra-wide band communication signals, or Bluetooth communications or any other type of signal suitable for wireless communications as understood in the field. As can be understood, the wireless communicator 36 can operate to transmit information over the air (OTA).

The speaker system 12 includes both internal speakers 12A and external speakers 12B. The internal speakers 12A are positioned within the passenger compartment PC and are disposed to provide sounds to the passenger compartment PC. The internal speakers 12A are configured to be controlled by the electronic controller 14 and play a sound package that has been downloaded by the vehicle V or a user U to the computer memory 16. The external speakers 12B are positioned on the vehicle V and are disposed to provide sounds to the exterior of the vehicle V. The external speakers 12B are configured to be controlled by the electronic controller 14 and play a sound package that has been downloaded by the vehicle V or a user U to the computer memory 16.

The display device 38 can be a display that is capable of displaying information. As described herein, the information that is displayed can be at least one of status information of related to the vehicle V as is known in the art. Preferably, the display device 38 includes an input 40. The input 40 in this embodiment can be touch screen (or a user interface UI). Thus, in one embodiment, the display device 38 functions as both the user interface and a notification device. The display device 38 and/or the input can include a graphical operator interface (GUI) to enable a vehicle occupant to change settings in the vehicle V, operate the sound system 10 and provide any information input necessary for operation of the vehicle V and the vehicle control system 22.

The CAN 20 is a communication protocol that allows various electronic devices within a vehicle V to exchange data with each other efficiently and reliably. As can be understood the CAN 20 essentially acts like a nervous system by connecting different electronic control units (ECUs) and enabling communication without the need for a central host computer. As illustrated in FIG. 1, the components in the vehicle V are connected to the CAN 20 to enable the electronic controller 14 to receive data from the various vehicle V systems and operate the sound system 10, as described herein.

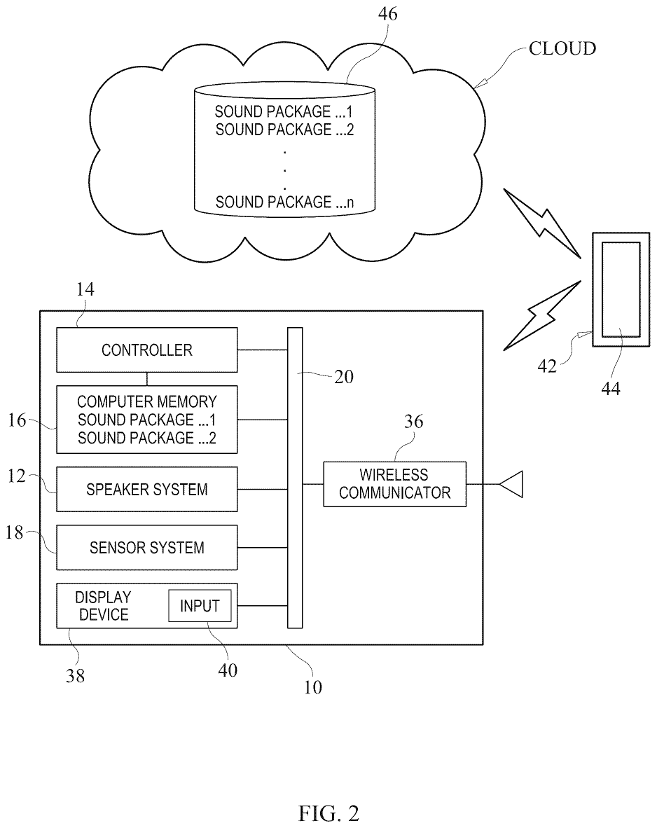

FIG. 2 is a simplified schematic illustration of the sound system 10. While not all of the components illustrated in FIG. 1 are illustrated in FIG. 2, this is merely exemplary to simply the description there of and is not meant to limit or change the scope of the description of FIG. 1. In this embodiment, the user U can operate a user interface 42 to view available sound packages at a remote server. In this embodiment the user interface 42 can be a remote device, such as a cell phone, a tablet or other device that includes an input 44. Similar to the display device 38 described above the user interface 42 in this embodiment can include touch screen (or a user interface UI). Thus, in one embodiment, the user interface 42 functions as both the user interface and a notification device. The user interface 42 can include a graphical operator interface (GUI) to enable a user to change settings in the vehicle V, operate the sound system 10 and provide any information input necessary for operation of the vehicle V and the vehicle control system 22.

However, in this embodiment, and as noted in FIG. 1, the user interface can be a display screen disposed within the passenger compartment PC of the vehicle V. Once the sound package is selected on the user interface 42 the sound package is downloaded by the wireless communicator 36 and stored in the computer memory 16. As described herein, the wireless communicator 36 can download the sound package over the air (OTA) from a remote location, such as a remote server 46, or in any other suitable manner.

In one embodiment, the user U can download an application (app) that enables the user U to view and select a sound package from a plurality of sound packages from the cloud or a remote server 46. As described above, plurality of sound packages can be downloaded OTA from the remote server 46. Moreover, the user U can select multiple sound packages from the plurality of available sound packages. Here, the user has selected sound package 1 and sound package 2 to be downloaded into the sound system 10.

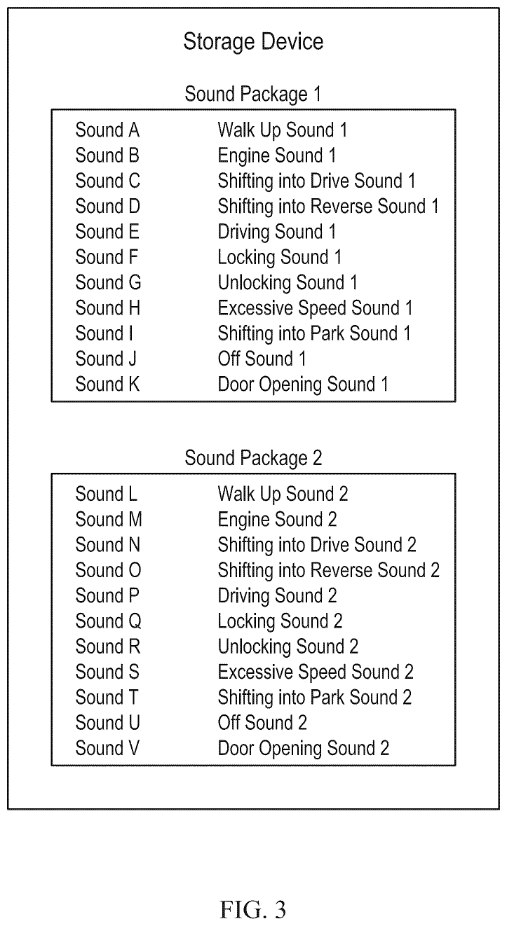

As illustrated in FIG. 3, the sound packages can have various sounds associated with various vehicle V activities. Table 1 and Table 2 illustrate the sounds associated with various vehicle V activities.

TABLE 1
Sound Package 1

| | |
|---|---|
| Sound A | Walk Up Sound 1 |
| Sound B | Engine Sound 1 |
| Sound C | Shifting into Drive Sound 1 |
| Sound D | Shifting into Reverse Sound 1 |
| Sound E | Driving Sound 1 |
| Sound F | Locking Sound 1 |
| Sound G | Unlocking Sound 1 |
| Sound H | Excessive Speed Sound 1 |
| Sound I | Shifting into Park Sound 1 |
| Sound J | Off Sound 1 |
| Sound K | Door Opening Sound 1 |

TABLE 2
Sound Package 2

| | |
|---|---|
| Sound L | Walk Up Sound 2 |
| Sound M | Engine Sound 2 |
| Sound N | Shifting into Drive Sound 2 |
| Sound O | Shifting into Reverse Sound 2 |
| Sound P | Driving Sound 2 |
| Sound Q | Locking Sound 2 |
| Sound R | Unlocking Sound 2 |
| Sound S | Excessive Speed Sound 2 |
| Sound T | Shifting into Park Sound 2 |
| Sound J | Off Sound 2 |
| Sound K | Door Opening Sound 2 |

The various sounds in the sound packages can be different from one another. That is, the walk up sound in sound package 1 (i.e., the walk up sound 1) can be different to the walk up sound in sound package 2 (i.e., the walk up sound 2). In one embodiment, a first user can be associated with the sound package 1 and a second user can be associated with sound package 2.

The sounds for each of the vehicle V activities is explained as follows. In general, a sensor within the sensor system 18 is configured to sense a parameter pertaining to the vehicle V. The can receives an electronic signal from the sensor system 18, the electronic signal pertaining to the parameter, and the electronic controller 14 determines a corresponding sound from the sound package based on the electronic signal received by the CAN and operate the speaker system 12 to play the sound.

In one embodiment, the sensor system 18 determines that a specific user is approaching the vehicle V. Thus, the walk up sound is the sound that the sound system 10 plays when a user is approaching or “walking up” to the vehicle V. Here, the sound system 10 can sense a specific user. For example, the sensor system 18 can use any of the vehicle V sensors to determine a first user is approaching the vehicle V. Such a determination can be made automatically using a key fob, a cell phone (i.e., user interface 42) or identification using a camera (e.g., cameras 30) or other sensor can be used to determine that the first user is approaching the vehicle V. Alternatively, the user can activate the walk up sound manually using the key fob or cell phone (i.e., user interface 42), or in any other manner desired. Because the first user is associated with sound package 1 in the sound system 10, the electronic controller 14 will play walk up sound 1. Walk up sound 1 can be a unique song, sound or combination of sounds that is played. Alternatively, when the sensor system 18 determines that the second user is approaching the vehicle V, walk up sound 2 can be played.

The walk up sound can be played by the external speakers 12B to enable the user and/or persons external to the vehicle V to hear the walk up sound. Alternatively or in conjunction with the external speakers 12B, the walk up sound can be played by the internal speakers 12A. Thus, an occupant in the passenger compartment PC would be able to hear the walk up sound as the user is approaching the vehicle V.

In one embodiment, the sensor system 18 determines that a specific user has started the vehicle V. Thus, the engine sound is the sound that the sound system 10 plays when a user has started the engine to the vehicle V or has simply entered the passenger compartment PC of the vehicle V. Here, the sound system 10 can sense a specific user. For example, the sensor system 18 can use any of the vehicle V sensors to determine that a first user is entering or has entered the vehicle V. Such a determination can be made automatically using a key fob, a cell phone (i.e., user interface 42) or identification using a camera (e.g., cameras 30) or other sensor can be used to determine that the first user is entering or has entered the vehicle V. Alternatively, the user can activate the engine sound manually using the key fob or cell phone (i.e., user interface 42) or display device 38, or in any other manner desired. Because the first user is associated with sound package 1 in the sound system 10, the electronic controller 14 will play engine sound 1. Engine sound 1 can be a unique song, sound or combination of sounds that is played. Alternatively, when the sensor system 18 determines that the second user is entering or has entered the vehicle V, engine sound 2 can be played.

The engine sound can be played by the external speakers 12B to enable persons external to the vehicle V to hear the engine sound. Alternatively or in conjunction with the external speakers 12B, the engine sound can be played by the internal speakers 12A. Thus, an occupant in the passenger compartment PC would be able to hear the engine sound as the user enters or is disposed within the passenger compartment PC of the vehicle V.

In one embodiment, the sensor system 18 determines that a specific user has shifted into drive. Thus, the shifting into drive sound is the sound that the sound system 10 plays when a user has shifted the vehicle V transmission into drive. Here, the sound system 10 can sense a specific user. For example, the sensor system 18 can use any of the vehicle V sensors to determine that a first user has shifted the vehicle V transmission into drive. Such a determination can be made automatically using a key fob, a cell phone (i.e., user interface 42) or identification using a camera (e.g., cameras 30) or other sensor can be used to determine that the first user has shifted the vehicle V transmission into drive. Alternatively, the user can activate the shifting into drive sound manually using the key fob or cell phone (i.e., user interface 42) or display device 38, or in any other manner desired. Because the first user is associated with sound package 1 in the sound system 10, the electronic controller 14 will play shifting into drive sound 1. Shifting into drive sound 1 can be a unique song, sound or combination of sounds that is played. Alternatively, when the sensor system 18 determines that the second user has shifted the vehicle V transmission into drive, shifting into drive sound 2 can be played.

The shifting into drive sound can be played by the external speakers 12B to enable persons external to the vehicle V to hear the shifting into drive sound. Alternatively or in conjunction with the external speakers 12B, the shifting into drive sound can be played by the internal speakers 12A. Thus, an occupant in the passenger compartment PC would be able to hear the shifting into drive sound as the user shifts the transmission into drive.

In one embodiment, the sensor system 18 determines that a specific user has shifted into reverse. Thus, the shifting into reverse sound is the sound that the sound system 10 plays when a user has shifted the vehicle V transmission into reverse. Here, the sound system 10 can sense a specific user. For example, the sensor system 18 can use any of the vehicle V sensors to determine that a first user has shifted the vehicle V transmission into reverse. Such a determination can be made automatically using a key fob, a cell phone (i.e., user interface 42) or identification using a camera (e.g., cameras 30) or other sensor can be used to determine that the first user has shifted the vehicle V transmission into reverse. Alternatively, the user can activate the shifting into reverse sound manually using the key fob or cell phone (i.e., user interface 42) or display device 38, or in any other manner desired. Because the first user is associated with sound package 1 in the sound system 10, the electronic controller 14 will play shifting into reverse sound 1. Shifting into reverse sound 1 can be a unique song, sound or combination of sounds that is played. Alternatively, when the sensor system 18 determines that the second user has shifted the vehicle V transmission into reverse, shifting into reverse sound 2 can be played.

The shifting into reverse sound can be played by the external speakers 12B to enable persons external to the vehicle V to hear the shifting into reverse sound. Alternatively or in conjunction with the external speakers 12B, the shifting into reverse sound can be played by the internal speakers 12A. Thus, an occupant in the passenger compartment PC would be able to hear the shifting into reverse sound as the user shifts the transmission into reverse.

In one embodiment, the sensor system 18 determines that a specific user is driving the vehicle V. Thus, the driving sound is the sound that the sound system 10 plays when a user is driving the vehicle V. Here, the sound system 10 can sense a specific user. For example, the sensor system 18 can use any of the vehicle V sensors to determine that a first user is driving. Such a determination can be made automatically using a key fob, a cell phone (i.e., user interface 42) or identification using a camera (e.g., cameras 30) or other sensor can be used to determine that the first user is driving. Alternatively, the user can activate driving sound manually using the key fob or cell phone (i.e., user interface 42) or display device 38, or in any other manner desired. Because the first user is associated with sound package 1 in the sound system 10, the electronic controller 14 will play the driving sound 1. Locking sound 1 can be a unique song, sound or combination of sounds that is played. Alternatively, when the sensor system 18 determines that the second user is driving, driving sound 2 can be played.

The driving sound can be played by the external speakers 12B to enable persons external to the vehicle V to hear the driving sound. Alternatively or in conjunction with the external speakers 12B, the driving sound can be played by the internal speakers 12A. Thus, an occupant in the passenger compartment PC would be able to hear the driving sound as the user drives the vehicle V.

In one embodiment, the sensor system 18 determines that a specific user is locking the vehicle V. Thus, the locking sound is the sound that the sound system 10 plays when a user is locking the vehicle V. Here, the sound system 10 can sense a specific user. For example, the sensor system 18 can use any of the vehicle V sensors to determine that a first user is locking the vehicle V. Such a determination can be made automatically using a key fob, a cell phone (i.e., user interface 42) or identification using a camera (e.g., cameras 30) or other sensor can be used to determine that the first user is locking the vehicle V. Alternatively, the user can activate the locking sound manually using the key fob or cell phone (i.e., user interface 42) or display device 38, or in any other manner desired. Because the first user is associated with sound package 1 in the sound system 10, the electronic controller 14 will play the locking sound 1. Locking sound 1 can be a unique song, sound or combination of sounds that is played. Alternatively, when the sensor system 18 determines that the second user is locking the vehicle V, locking sound 2 can be played.

The locking sound can be played by the external speakers 12B to enable persons external to the vehicle V to hear the locking sound. Alternatively or in conjunction with the external speakers 12B, the locking sound can be played by the internal speakers 12A. Thus, an occupant in the passenger compartment PC would be able to hear the locking sound as the user locks the vehicle V.

In one embodiment, the sensor system 18 determines that a specific user is unlocking the vehicle V. Thus, the unlocking sound is the sound that the sound system 10 plays when a user is unlocking the vehicle V. Here, the sound system 10 can sense a specific user. For example, the sensor system 18 can use any of the vehicle V sensors to determine that a first user is unlocking the vehicle V. Such a determination can be made automatically using a key fob, a cell phone (i.e., user interface 42) or identification using a camera (e.g., cameras 30) or other sensor can be used to determine that the first user is unlocking the vehicle V. Alternatively, the user can activate the unlocking sound manually using the key fob or cell phone (i.e., user interface 42) or display device 38, or in any other manner desired. Because the first user is associated with sound package 1 in the sound system 10, the electronic controller 14 will play the unlocking sound 1. Unlocking sound 1 can be a unique song, sound or combination of sounds that is played. Alternatively, when the sensor system 18 determines that the second user is unlocking the vehicle V, unlocking sound 2 can be played.

The unlocking sound can be played by the external speakers 12B to enable persons external to the vehicle V to hear the unlocking sound. Alternatively or in conjunction with the external speakers 12B, the unlocking sound can be played by the internal speakers 12A. Thus, an occupant in the passenger compartment PC would be able to hear the unlocking sound as the user unlocks the vehicle V.

In one embodiment, the sensor system 18 determines that a specific user is engaging in excessive speed. Thus, the excessive speed sound is the sound that the sound system 10 plays when a user is engaging in excessive speed. Here, the sound system 10 can sense a specific user. For example, the sensor system 18 can use any of the vehicle V sensors to determine that a first user is engaging in excessive speed. Such a determination can be made automatically using a key fob, a cell phone (i.e., user interface 42) or identification using a camera (e.g., cameras 30) or other sensor can be used to determine that the first user is engaging in excessive speed. Alternatively, the user can activate the unlocking sound manually using the key fob or cell phone (i.e., user interface 42) or display device 38, or in any other manner desired. Because the first user is associated with sound package 1 in the sound system 10, the electronic controller 14 will play the excessive speed sound 1. Excessive speed sound 1 can be a unique song, sound or combination of sounds that is played. Alternatively, when the sensor system 18 determines that the second user is engaging in excessive speed, excessive speed sound 2 can be played.

The excessive speed sound can be played by the external speakers 12B to enable persons external to the vehicle V to hear the excessive speed sound. Alternatively or in conjunction with the external speakers 12B, the excessive speed sound can be played by the internal speakers 12A. Thus, an occupant in the passenger compartment PC would be able to hear the excessive speed sound as the user engages in excessive speed.

In one embodiment, the sensor system 18 determines that a specific user has shifted into park. Thus, the shifting into park sound is the sound that the sound system 10 plays when a user has shifted the vehicle V transmission into park. Here, the sound system 10 can sense a specific user. For example, the sensor system 18 can use any of the vehicle V sensors to determine that a first user has shifted the vehicle V transmission into park. Such a determination can be made automatically using a key fob, a cell phone (i.e., user interface 42) or identification using a camera (e.g., cameras 30) or other sensor can be used to determine that the first user has shifted the vehicle V transmission into park. Alternatively, the user can activate the shifting into park sound manually using the key fob or cell phone (i.e., user interface 42) or display device 38, or in any other manner desired. Because the first user is associated with sound package 1 in the sound system 10, the electronic controller 14 will play shifting into park sound 1. Shifting into park sound 1 can be a unique song, sound or combination of sounds that is played. Alternatively, when the sensor system 18 determines that the second user has shifted the vehicle V transmission into park, shifting into park sound 2 can be played.

The shifting into park sound can be played by the external speakers 12B to enable persons external to the vehicle V to hear the shifting into park sound. Alternatively or in conjunction with the external speakers 12B, the shifting into park sound can be played by the internal speakers 12A. Thus, an occupant in the passenger compartment PC would be able to hear the shifting into park sound as the user shifts the transmission into park.

In one embodiment, the sensor system 18 determines that a specific user has turned off the vehicle V. Thus, the off sound is the sound that the sound system 10 plays when a user has turned off the vehicle V. Here, the sound system 10 can sense a specific user. For example, the sensor system 18 can use any of the vehicle V sensors to determine that a first user turned off the vehicle V. Such a determination can be made automatically using a key fob, a cell phone (i.e., user interface 42) or identification using a camera (e.g., cameras 30) or other sensor can be used to determine that the first user is entering or has entered the vehicle V. Alternatively, the user can activate the off sound manually using the key fob or cell phone (i.e., user interface 42) or display device 38, or in any other manner desired. Because the first user is associated with sound package 1 in the sound system 10, the electronic controller 14 will cause the off sound 1 to be emitted from the speaker system 12. Off sound 1 can be a unique song, sound or combination of sounds that is played. Alternatively, when the sensor system 18 determines that the second user has turned off the vehicle V, off sound 2 can be played.

The off sound can be played by the external speakers 12B to enable persons external to the vehicle V to hear the engine sound. Alternatively or in conjunction with the external speakers 12B, the off sound can be played by the internal speakers 12A. Thus, an occupant in the passenger compartment PC would be able to hear the off sound as the user turns off the vehicle V.

In one embodiment, the sensor system 18 determines that a specific user is opening the door of the vehicle V. Thus, the door opening sound is the sound that the sound system 10 plays when a user is opening the door to the vehicle V. Here, the sound system 10 can sense a specific user. For example, the sensor system 18 can use any of the vehicle V sensors to determine a first user is opening the door of the vehicle V. Such a determination can be made automatically using a key fob, a cell phone (i.e., user interface 42) or identification using a camera (e.g., cameras 30) or other sensor can be used to determine that the first user is opening the door of the vehicle V. Alternatively, the user can activate the door opening sound manually using the key fob or cell phone (i.e., user interface 42), or in any other manner desired. Because the first user is associated with sound package 1 in the sound system 10, the electronic controller 14 will play door opening sound 1. Door opening sound 1 can be a unique song, sound or combination of sounds that is played. Alternatively, when the sensor system 18 determines that the second user is opening the door of the vehicle V, door opening sound 2 can be played.

The door opening sound can be played by the external speakers 12B to enable the user and/or persons external to the vehicle V to hear the door opening sound. Alternatively or in conjunction with the external speakers 12B, the door opening sound can be played by the internal speakers 12A. Thus, an occupant in the passenger compartment PC would be able to hear the door opening sound as the user is opening the door of the vehicle V.

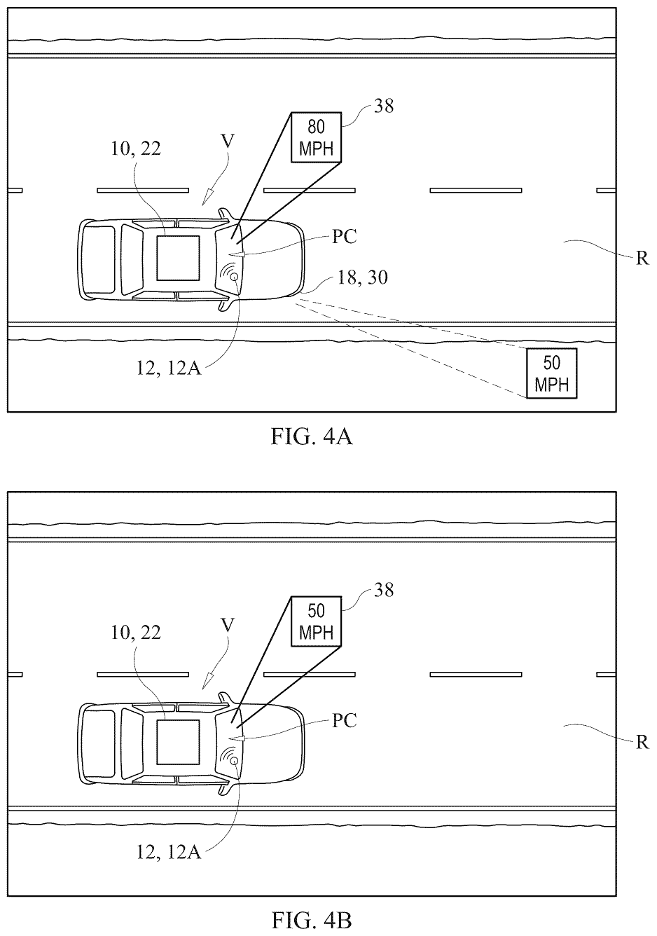

FIGS. 4A and 4B illustrate the vehicle control system 22 working in conjunction with the sound system 10. In this embodiment, the as the vehicle V is traveling along the road R, the vehicle control system 22 determines that the vehicle V is traveling at 80 mph. The speed of 80 mph can be displayed on the display device 38 within the passenger compartment PC of the vehicle V. The vehicle speed can be determined using the sensor system 18, for example, the vehicle sensor 18, which includes a vehicle speed sensor, as discussed herein. Moreover, the vehicle control system 22 can determine that the road R has a speed limit of 50 mph. In the illustrated embodiment, the vehicle V uses an environmental sensor, such as a camera 30 to read the speed limit sign. The environmental sensor is able to sense the speed limit sign and provide this information to the electronic controller 14 through the CAN 20. It is noted that the speed of the vehicle V and/or the speed limit sign can be determined by any suitable vehicle V system. For example, the navigation device 34 can be used to determine the location and speed of the vehicle V. Location of the vehicle V can be determined based on the road R and a data table having the speed limit for the road R can be used.

Once the electronic controller 14 determines that the vehicle V is traveling at a speed above the speed limit (an excessive speed), the sound system 10 can cause the excessive sound (e.g., excessive sound 1) to be played by the speaker system 12, as described herein. In one embodiment, the an excessive speed notification can be displayed on the display device 38 and/or the user interface 42. Simultaneously, the vehicle control system 22 can operate the vehicle actuator 32 to operate the braking device and/or the controls for the engine to automatically reduce the vehicle V speed to ensure the vehicle V is not operating at an excessive speed. As shown in FIG. 4B, the vehicle control system 22 can then determine that the vehicle V is traveling at the proper speed (i.e., 50 mph). In the same manner as described above the vehicle control system 22 can determine the vehicle speed using the sensor system 18.

It is further noted that similar operations can be performed using the vehicle actuator 32 to operate the steering device 26 to change lanes on the road R to operate the vehicle in an autonomous or semiautonomous manner desired. As described herein a sound from a sound package can be played through the speaker system 18, as described herein in anticipation of this action, during this action or any other suitable time in association with the action.

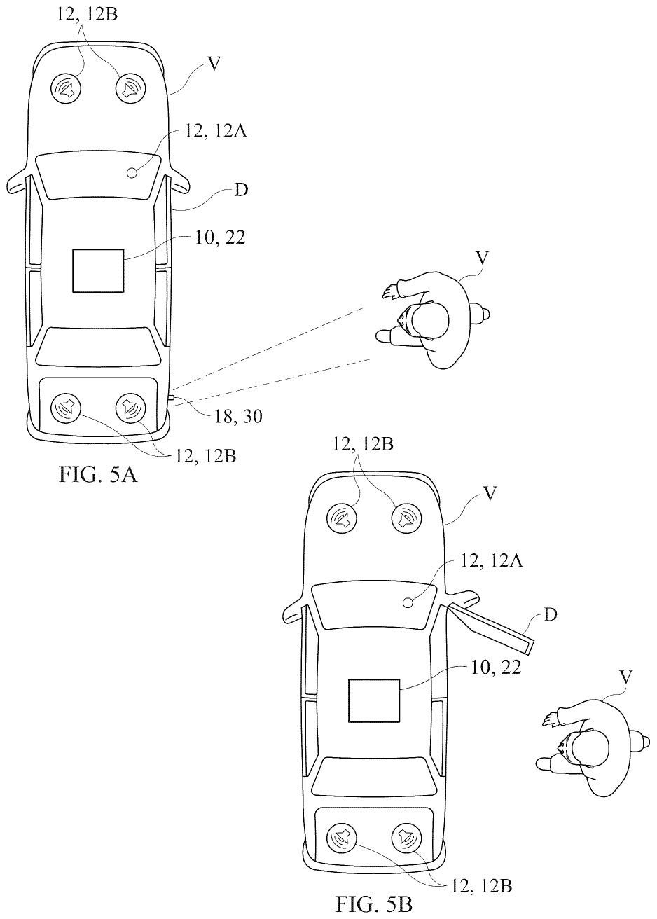

As illustrated in FIGS. 5A and 5B, the vehicle control system 22 can work in conjunction with the sound system 10. In this embodiment, the user U is approaching the vehicle V, the sound system 10 determines that a user is approaching the vehicle V, as described herein. In the illustrated embodiment, the sensor system 18, such as camera 30 can determine that the first user U is approaching the vehicle V. The sensor system 18 is able to sense the first user U and provide this information to the electronic controller 14 through the CAN 20. It is noted that the first user U can be determined by any suitable vehicle system as described herein.

Once the electronic controller 14 determines that the first user U is approaching the vehicle V, the sound system 10 can cause the walk up sound (e.g., walk up sound 1) to be played by the speaker system 12, as described herein. Simultaneously, the vehicle control system 22 can operate the door D to open the door D for the first user U, as shown in FIG. 5B.

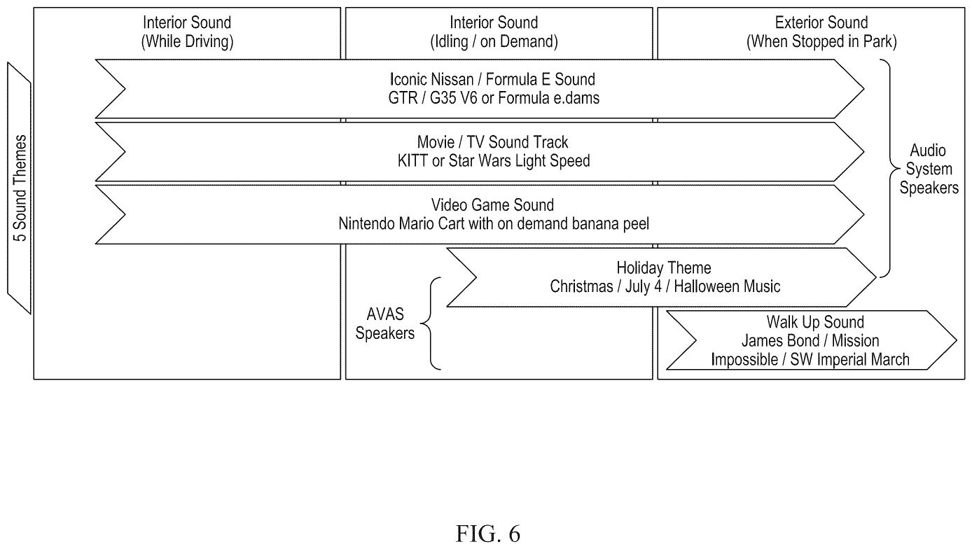

FIG. 6 illustrates one embodiment of the different sound themes, and when the sound themes are played by the external speakers 12B and when the sound themes are played by the internal speakers 12A. As illustrated there can be three different situations in which the sound theme may be played. In the first situation, the sound themes can be played by the interior speakers while the vehicle V is in a driving mode.

In one embodiment the internal speakers 12A can play a sound related to a vehicle driving sound. For example, the internal speakers 12A can be play the iconic Nissan sound, a formula E sound, the GTR sound, the G35 sound or the Formula e.dams sound. In other embodiments, the internal speakers 12A can play movie or tv car sounds such as Knight Rider sounds (KITT) or STAR WARS (light speed) sounds. In another embodiment, the internal speakers 12A can play video games sounds, such as MARIO KART sounds.

These sounds can also be played by the internal speakers 12A when idling or when desired by the occupants of the vehicle V (e.g., on demand). Moreover, these sounds can be played by the external speakers 12B when the vehicle V is stopped or in park. It is noted that the internal speakers 12A and the external speakers 12B can play these sounds at any time desired.

The internal speakers 12A can also play themed type sounds when idling or on demand. For example, Holiday Music, independence Day (July 4) music or any other type of music can be played. These types of sounds can also be played by the external speakers 12B.

Further, as illustrated in FIG. 6, the walk up sound can be themed music, such as James Bond, Mission Impossible, or STAR WARS Imperial March. As illustrated in FIG. 6, these themes can be played by the external speakers 12B. However, as discussed herein, these themes can also be played by the internal speakers 12A.

It is noted that as discussed herein, the themes of music and sounds discussed in FIG. 6 can be associated with a specific user as discussed herein.

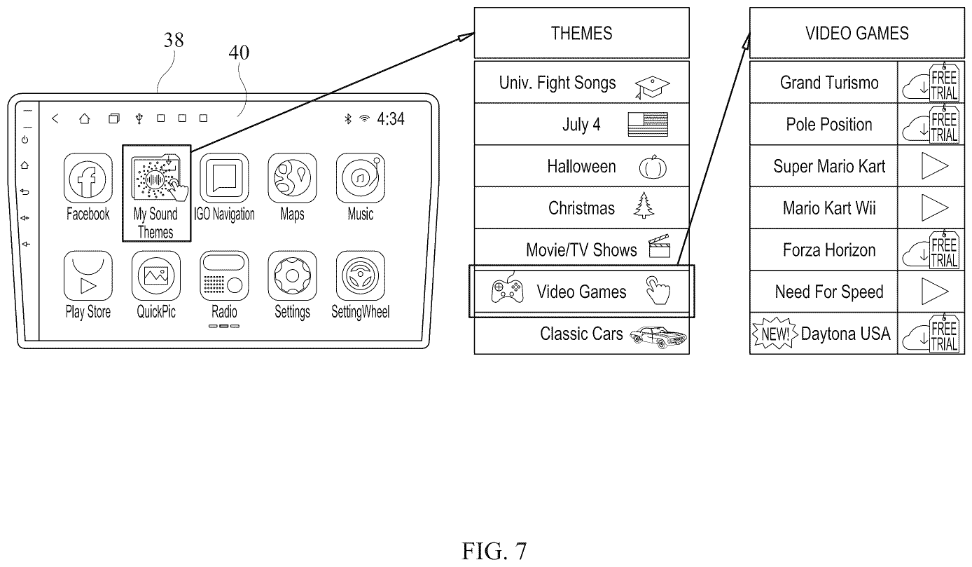

FIG. 7 illustrates the display device 38 with a GUI (input 40). Here, the user can select from the downloaded sound packages, a specific sound package from the display device 38. As discussed herein, the sound packages can be downloaded from the cloud or a remote server 46 and stored in the computer memory 16. In one embodiment, the sound packages can be downloaded from the cloud or a remote server 46 OTA or in any suitable manner. Accordingly, the various sound packages (e.g., sound package 1 and sound package 2) are available for selection and/or assignment to a specific user.

In this embodiment, the user selects a video game sound package and then is provided with a specific video game package to select within the video game sound package. The user can then select, for example, the GRAND TURISMO sound package. In this sound package individual sounds for sounds A-K can be assigned a “GRAND TURISMO” sound. Thus, when a user walks up to the vehicle V a “GRAND TURISMO” walk up sound can be played. It will be understood that each sound package can have its own individual sound for each of the types of sounds described herein. Alternatively, the sound packages can overlap some sounds and share some of the same sounds. In another embodiment, the user can mix and match sounds within the sound packages to provide a unique user sound package. In one example, the user can pick the imperial march from STAR WARS as a walk up sound (sound A) and an iconic Nissan driving sound as the engine sound (sound E).

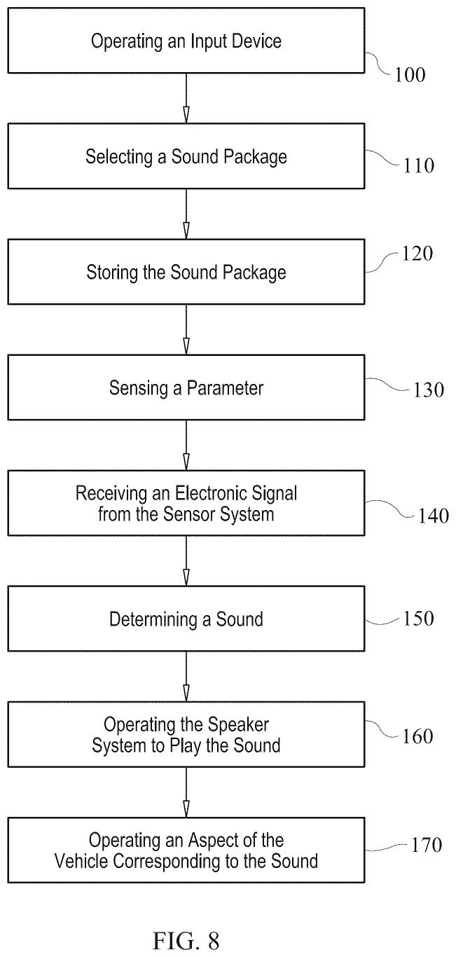

FIG. 8 illustrates a method of operation of the sound system 10. In step 100, the user can operate an input 40. In step 110, using the input 40, the user can select a sound package. For example, the user can select sound package 1 or sound package 2. An electronic signal can be sent from the user input 40 on the display device 38 and into the CAN 20. Once the user has selected a sound package, the sound package is associated with the user. In other words, the electronic signal is sent through the CAN and the sound system 10 in step 120 stores the sound package into the computer memory 16 and associates the sound package with the specific user. Then, when the sound system 10 senses a parameter of the vehicle V using the sensor system 18 in step 130. The controller 14 then receives the electronic signal from the sensor system 18 in step 140. In one embodiment, the electronic signal is sent from the sensor system 18 through the CAN 20 to the electronic controller 14. The electronic controller 14 determines the appropriate sound in step 150, based on the electronic signal from the sensor system 18. In step 160, the electronic controller 14 operates the speaker system 12 to play the sound, as discussed herein. As can be understood, in one embodiment, the electronic controller 14 sends an electronic signal through the CAN 20 to the speaker system 12 to operate the speakers 12A and/or 12B to play the sound. Finally, in one embodiment, the vehicle control system 22 can operate an aspect of the vehicle V corresponding to the sound, in step 170. Preferably, as described herein, the controller 14 sends an operation signal through the CAN 20 operate an aspect of the vehicle V, as described herein.

As discussed herein, the operation of the vehicle V can include operating an aspect of the vehicle V to relation to a sensed parameter. For example, the vehicle control system 22 can perform any operation or perform any mitigation operation desired. As discussed herein, the vehicle control system 22 can operate the speed of the vehicle V, the direction of the vehicle V or open a vehicle V door. However, the operation of the vehicle control system 22 is not limited to these operations and can include lane change operation, turning operations, turn signal operations, vehicle emergency operations or any vehicle V control operation. The operation can also include any light notification operation displayed on the display device 38 or the user interface 42, haptic operation or any other operation intended to notify the vehicle V occupants or external people in the vicinity of the vehicle V.

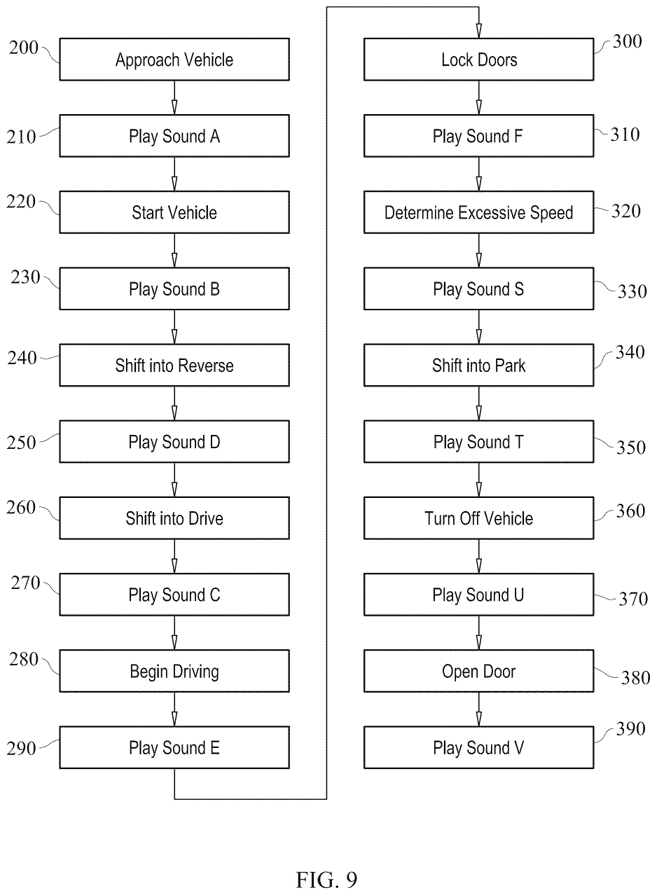

FIG. 9 illustrates a method of operation for a user that has selected a unique combination of sound package 1 and sound package 2. Here, as the user approaches the vehicle V in step 200, sound A is played by the sound system 10 in step 210. When the user enters the vehicle V and starts the vehicle V in step 220, sound B 230 is played. When the user then shifts into reverse in step 240, sound D is played in step 250. When the user shifts into drive in step 260, sound C is played in step 270. When the user begins driving in step 280 sound E is played in step 290, and when the user locks the doors in step 300, sound F is played in step 310. When the vehicle control system 22 determines that excessive speed has been obtained in step 320, sound S is played in step 330, and when the user shifts into park in step 340, sound T is played in step 350. When the user turns off the vehicle V in step 360, sound U is played in step 370, and when the user opens the door and exits the vehicle V in step 380 sound V is played in step 390.

In one embodiment, the sound system 10 can include a non-transitory machine-readable medium storing instructions which, when executed by one or more processor, causes the one or more processor to execute the method disclosed herein. For example, in one embodiment, the non-transitory machine-readable medium storing instructions which, when executed by one or more processor, causes one or more processor (i.e., controller 14) in the sound system 10 to select a sound from a sound package stored in the storage device (computer memory 16) based on an electronic signal from the sensor system 18, and operate the speaker system to play the sound.

In one embodiment, the controller 14 comprises the non-transitory machine-readable medium discussed above.

While specific sounds for specific vehicle V parameters are set forth, these sounds are merely exemplary and any suitable sound or combination of sounds can be played. Moreover, the user can mix and match and user any sounds desired to produce a unique sound package or use the predetermined sounds within a sound package.

By providing a sound system 10 as described herein, a unique and interesting sound system 10 can be provided for a vehicle user. Moreover, as discussed herein an improved user experience can be obtained. A user can select and organize specific sounds that are associated with specific vehicle operations. Moreover, the vehicle V can provide specific sounds to vehicle occupants and external observers that provides notification of an operation that should performed or notification that the vehicle V is intending to or is in the process of performing a specific operation.

The satellite navigation system and wireless communicator are conventional components that are well known in the art. Since satellite navigation system and wireless communicator are well known in the art, these structures will not be discussed or illustrated in detail herein. Rather, it will be apparent to those skilled in the art from this disclosure that the components can be any type of structure and/or programming that can be used to carry out the present disclosure.

### GENERAL INTERPRETATION OF TERMS

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the sound system. Accordingly, these terms, as utilized to describe the present disclosure should be interpreted relative to a vehicle equipped with the sound system.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present disclosure, it will be apparent to those skilled in the art from this disclosure that various changes and modifications can be made herein without departing from the scope of the disclosure as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further disclosures by the applicant, including the structural and/or functional concepts embodied by such feature(s). Thus, the foregoing descriptions of the embodiments according to the present disclosure are provided for illustration only, and not for the purpose of limiting the disclosure as defined by the appended claims and their equivalents.

What is claimed is:

1. A sound system for a vehicle, comprising:
an input configured to enable a user to select a sound package from a plurality of sound packages;
a storage device configured to store the sound package;
a speaker system;
a sensor system configured to sense a parameter pertaining to the vehicle;
a CAN configured to receive an electronic signal from the sensor system, the electronic signal pertaining to the parameter; and
an electronic controller configured to determine a sound from the sound package based on the electronic signal received by the CAN and operate the speaker system to play the sound.

2. The sound system for a vehicle according to claim 1, wherein
the sensor is configured to sense an external parameter pertaining to the vehicle.

3. The sound system for a vehicle according to claim 2, wherein
the external parameter is a location of an operator relative to the vehicle.

4. The sound system for a vehicle according to claim 3, wherein
the electronic controller is configured to operate a system of the vehicle to enable entry of the operator into a passenger compartment of the vehicle.

5. The sound system for a vehicle according to claim 1, wherein
the sensor is configured to sense a vehicle parameter pertaining to the vehicle.

6. The sound system for a vehicle according to claim 5, wherein
the vehicle parameter is at least one of vehicle speed, vehicle direction and vehicle location.

7. The sound system for a vehicle according to claim 6, wherein
the electronic controller is configured to control an operating system to change the least one of vehicle speed, vehicle direction and vehicle location.

8. The sound system for a vehicle according to claim 1, wherein
the sound package is a first sound package, and the input is configured to enable a user to select a second sound package from the plurality of sound packages, the input being configured to enable the user to storge a portion of the first sound package and a portion of the second sound package in the storage device.

9. The sound system for a vehicle according to claim 1, wherein
the electronic controller is configured to operate the speaker system to play the sound by transmitting a signal through the CAN to the speaker system.

10. A method of operating a sound system for a vehicle, comprising:
operating an input to select a sound package from a plurality of sound packages;
storing the sound package in a storage device;
sensing a parameter pertaining to the vehicle with a sensor system;
receiving an electronic signal from the sensor system with a CAN, the electronic signal pertaining to the parameter;
determining with an electronic controller a sound from the sound package based on the electronic signal received by the CAN; and
operating the speaker system to play the sound.

11. The method according to claim 10, wherein
the sensing a parameter includes sensing an external parameter pertaining to the vehicle.

12. The method according to claim 11, wherein
the sensing the external parameter includes sensing a location of an operator relative to the vehicle.

13. The method according to claim 12, further comprising
operating with the electronic controller a system of the vehicle to enable entry of the operator into a passenger compartment of the vehicle.

14. The method according to claim 10, wherein
the sensing a parameter includes sensing a vehicle parameter pertaining to the vehicle.

15. The method according to claim 14, wherein
the sensing the vehicle parameter pertaining to the vehicle includes sensing at least one of vehicle speed, vehicle direction and vehicle location.

16. The method according to claim 15, further comprising
controlling with the electronic controller an operating system to change the least one of vehicle speed, vehicle direction and vehicle location.

17. The method according to claim 10, wherein
the sound package is a first sound package, and the operating the input includes operating the to enable a user to select a second sound package from the plurality of sound packages, and storing a portion of the first sound package and a portion of the second sound package in the storage device.

18. A non-transitory machine-readable medium storing instructions which, when executed by one or more processor, causes the one or more processor to execute a method comprising selecting a sound from a sound package stored in a storage device based on an electronic signal received through a CAN and to the CAN from a sensor system, and operate a speaker system to play the sound.

19. A controller comprising the non-transitory machine-readable medium of claim 18.
